(19) United States
(12) Patent Application Publication
(10) Pub. No.: US 2024/0316538 A1
(43) Pub. Date: Sep. 26, 2024

(54) ALUMINUM NITRIDE CERAMIC, AND PREPARATION METHOD THEREOF

(71) Applicant: HYDROGEN SOURCE TECHNOLOGY (JIANGSU) CO., LTD., Yangzhou (CN)

(72) Inventors: Hanning XIAO, Yangzhou (CN); Li NI, Yangzhou (CN); Zhongwen ZHU, Yangzhou (CN); Chenxu GUO, Yangzhou (CN)

(21) Appl. No.: 18/733,256

(22) Filed: Jun. 4, 2024

Related U.S. Application Data
(63) Continuation of application No. PCT/CN2023/100654, filed on Jun. 16, 2023.

(30) Foreign Application Priority Data
Jun. 24, 2022 (CN) 202210722452.5

(51) Int. Cl. B01J 23/755; B01J 19/00; B01J 23/889; B01J 27/24; B01J 35/45; B01J 35/56; B01J 35/64; B01J 37/00; B01J 37/02; B01J 37/03; B01J 37/04; B01J 37/08; C01B 3/32

(52) U.S. Cl. CPC B01J 23/755; B01J 19/0093; B01J 23/8892; B01J 27/24; B01J 35/45; B01J 35/56; B01J 35/657; B01J 37/0018; B01J 37/0219; B01J 37/0228; B01J 37/0244; B01J 37/035; B01J 37/04; B01J 37/08; C01B 3/326; B01J 2219/00835; B01J 2219/00882; C01B 2203/0227; C01B 2203/0855; C01B 2203/1029; C01B 2203/1058; C01B 2203/1082; C01B 2203/1217

(57) ABSTRACT

An Aluminum nitride ceramic and preparation method thereof. The aluminum nitride ceramic comprises a porous aluminum nitride matrix. A ferrite is loaded on the pore surface of the porous aluminum nitride matrix; and nano nickel particles are loaded on the surface of the ferrite. The preparation method of the aluminum nitride ceramic comprises steps: sintering the aluminum nitride ceramic by pressureless sintering method, depositing the ferrite on pore surface of porous aluminum nitride matrix by hydrothermal method, and loading nano nickel particles on the surface of the ferrite by reduction method. A micro-reactor is provided. So that the technical problems: the preheating time of the micro-reactor prepared is too long, nickel particles fall off from the surface of matrix, and nano nickel particles grow up due to quick and direct temperature rise can be solved.

### CROSS REFERENCE TO RELATED APPLICATIONS

This application is a Continuation of co-pending International Application No. PCT/CN2023/100654, filed on Jun. 16, 2023, for which priority is claimed under 35 U.S.C. § 120; and this application claims priority of Application No. 202210722452.5 filed in China on Jun. 24, 2022 under 35 U.S.C. § 119; the entire contents of all of which are hereby incorporated by reference.

### TECHNICAL FIELD

The application relates to ceramic, in particular to an aluminum nitride ceramic and its preparation method.

### BACKGROUND

The increasingly stringent global control of greenhouse gas carbon dioxide emissions. Therefore, China set the goal of “double carbon” (carbon peak and carbon neutrality). To achieve this goal, it is necessary to reduce the carbon emissions caused by fuel powered internal combustion engines used in transportation vehicles. Therefore, new energy vehicles have been rapidly promoted.

At present, new energy vehicles powered by lithium batteries have been increasingly widely used in the fields of passenger cars and buses. However, lithium batteries are difficult to meet the power needs of heavy equipment such as commercial vehicles, engineering vehicles, and ships. Hydrogen energy is considered as a green energy source that can provide power for the aforementioned equipment. Hydrogen energy includes hydrogen internal combustion engines and hydrogen fuel cells.

At present, hydrogen fuel cell vehicles mainly use high-pressure hydrogen tanks to store hydrogen gas. This storage method has problems such as high risk of detonation, limited range, and high cost of constructing hydrogen refueling stations. However, The hydrogen storage method for liquid hydrogen does not require high-pressure hydrogen tanks, and the hydrogen supply method for online hydrogen production in vehicles also does not require high-pressure hydrogen tanks.

On board online hydrogen production can use on board micro reactors to convert liquid hydrogen sources loaded in fuel tank such as methanol into hydrogen gas online. These hydrogen gases can be used for hydrogen internal combustion engines or hydrogen fuel cells. Online hydrogen production in vehicles has the advantages of efficiency, safety, and environmental protection, and is an important development direction for future new energy vehicles and hydrogen energy applications. Therefore, developing an onboard hydrogen production system that can directly and quickly convert liquid hydrogen sources into hydrogen will greatly accelerate the promotion and application of hydrogen powered vehicles.

The onboard hydrogen production system is a system that converts organic liquid fuels into hydrogen online. In existing systems, metal or high thermal conductivity ceramic are generally used as catalyst carriers to prepare micro reactors. This micro reactor is used for reforming to produce hydrogen. Take ethanol steam reforming (ESR) as an example. After heating the microreactor containing nickel particles to 500-1000° C., ethanol and water vapor are introduced into the microreactor. Ethanol and water vapor can react to generate hydrogen and carbon dioxide. The specific reaction equation is as follows:

However, the above reactions can only be carried out at temperatures ranging from 500 to 1000° C. Therefore, the preheating time of existing microreactors for reforming hydrogen production is too long, usually requiring more than 1 hour. If the microreactor is heated rapidly, the nickel particles may fall off from the surface of the matrix because of the mismatch of the coefficient of thermal expansion of the matrix and the nickel particles. Moreover, rapid direct heating can also lead to the growth of nickel nanoparticles.

Therefore, the existing technology has the following problems:

The preheating time of the microreactor is too long; Usually takes more than 1 hour;

The load bonding strength of nickel particles is low;

Nickel particles are prone to grow, leading to a decrease in their catalytic efficiency.

### SUMMARY

Purpose of the application: The purpose of the present application is to provide an aluminum nitride ceramic and its preparation method. The aluminum nitride ceramic can quickly transfer heat to the micro reactor. So that it can solve the technical problem such as: long preheating time of the micro reactor prepared by the aluminum nitride ceramic, the detachment of nickel particles from the matrix surface, and the growth of nano nickel particles resulted from rapid direct heating.

Technical solution: The aluminum nitride ceramic of the present application includes a porous aluminum nitride matrix; a pore wall surface of the porous aluminum nitride matrix is loaded with a ferrite; a surface of the ferrite is loaded with nano nickel particles with a particle size of 20-200 nm.

an apparent porosity rate of the porous aluminum nitride matrix is 35% to 70%. The porous aluminum nitride matrix has micron-order macropores. A diameter of the micron-order macropores is 50-200 microns.

A method of preparing the aluminum nitride ceramic comprising the following steps:
(1) mixing aluminum nitride powder and binder then add water to obtain aluminum nitride mud, then use extrusion molding method to shape the aluminum nitride mud to obtain the aluminum nitride green body. Sinter the green body to obtain the porous aluminum nitride matrix.
(2) Dissolve iron and manganese salt in organic solvents, then add sodium acetate, surfactants, and the porous aluminum nitride matrix prepared in step (1) into the organic solvents. After hydrothermal reaction, a porous aluminum nitride matrix loaded with ferrite is obtained.
(3) Place the porous aluminum nitride matrix loaded with ferrite in a nickel salt solution, then add onium salt and hydrazine solution. At last, the aluminum nitride ceramic is obtained.

The binder in step (1) comprises HPMC (Hydroxypropyl Methyl Cellulose), hydroxymethyl cellulose, hydroxyethyl cellulose, or CMC (Carboxymethyl cellulose). Iron salt comprises FeCl₃·6H₂O, manganese salt comprises MnCl₂··4H₂O, organic solvents comprises ethylene glycol, and surfactant comprises polyethylene glycol.

In detail, the step (2) is as follow: 3-5 g of FeCl₃·6H₂O and 1-2 g of MnCl₂·4H₂O are dissolved in 120-300 mL of ethylene glycol, then add 10-20 g of sodium acetate, 3-5 g of polyethylene glycol, and the porous aluminum nitride matrix prepared in step (1) into the ethylene glycol solvent. After hydrothermal reaction at 180-200° C., a porous aluminum nitride matrix loaded with ferrite is obtained.

In step (3), the concentration of nickel ions in the nickel salt solution is 1-3 mol/L, and the addition amount of onium salt in the nickel salt solution is 0.3-0.5 wt %.

The content of hydrazine in the hydrazine solution is 2-5 wt %.

A microreactor is prepared by cutting the aluminum nitride ceramic.

The microreactor of the application can be used to convert organic liquid fuel into hydrogen through catalytic reforming.

Specifically, the method comprising the following steps:
connect the gas delivering device with the air inlet end of the microreactor.
connect the gas chromatograph with the gas outlet end of the microreactor.
set a heating device and a magnetic field generating device around the micro reactor. feed organic liquid fuel into the micro reactor, and then start the heating device and the magnetic field generating device. The micro reactor can start hydrogen production after preheating.

The organic liquid fuels comprise alcohols containing 1-4 carbon atoms.

Mechanism: In order to solve the problem of long preheating time for microreactors, the application provides an aluminum nitride ceramic, which comprise a porous aluminum nitride matrix. The pore wall surface of the porous aluminum nitride matrix is loaded with ferrite. The surface of ferrite is loaded with nano nickel particles.

When in use, heat the aluminum nitride ceramic, meanwhile, set a magnetic field around, so that the nano nickel particles are heated to the temperature that can be used for catalytic reforming to produce hydrogen in a short time. Thus, the preheating time is shortened.

At the same time, at high temperature, nickel nanoparticles will also be embedded into ferrite due to atomic motion. This can increase the high-temperature migration barrier of nickel nanoparticles, and prevent the decrease in catalytic efficiency caused by the growth of nickel nanoparticles.

At the same time, the nano nickel particles are embedded and firmly bonded to the ferrite, which avoids nano nickel particles directly bond on the surface of the inert and smooth aluminum nitride ceramic matrix. This improves the load bonding strength of the nano nickel particles, and also, this effectively prevents the detachment of the nano nickel particles when water vapor flows into the microreactor at high speed and high pressure. As a result, the service life of the microreactor is extended.

The present application uses porous aluminum nitride as the matrix. Due to the high thermal conductivity of aluminum nitride, the micro reactor can quickly obtain heat from the outside, and keep the reaction stable.

Furthermore, the high-temperature strength of aluminum nitride ceramic is high, which enables the porous ceramic matrix of aluminum nitride to meet the pressure and strength required for hydrogen production through steam reforming. And the strength of aluminum nitride ceramic is high too, so that it can meet the pressure and strength required for system assembly as well.

Aluminum nitride has excellent corrosion resistance property. So, the matrix made of it cannot be corroded by water vapor or other factors during long-term hydrogen production, even though the matrix is of high specific surface area.

The coefficient of thermal expansion of aluminum nitride is low. This makes the size of porous aluminum nitride ceramic matrix changes little in the process of hydrogen production, so that the catalytic micro reactor can operate stably.

The apparent porosity rate of the porous aluminum nitride matrix of the present application is 35-70%. High porosity rate can provide sufficient reaction channels for reforming hydrogen production. While, if the porosity rate is too low, the reaction channels is not enough to keep high reaction efficiency, and if the porosity rate is too high, the strength of the matrix decreases.

The porous aluminum nitride matrix has micrometer sized large pores. The micron sized large pores have a large specific surface area, which can provide sufficient contact area for the reforming hydrogen production reaction.

The pore size of the micron sized large pores of the porous aluminum nitride ceramic is 50-200 microns. When the pore size is greater than 200 microns, the specific surface area of the porous aluminum nitride ceramic is too low to load enough amount of nano nickel. This makes the hydrogen production efficiency reduce, and improve risk of incomplete reaction.

When the pore size is less than 50 microns, the gas passing efficiency is low. it also reduces the efficiency of hydrogen production.

The method of preparing aluminum nitride ceramic comprise the following steps: sinter aluminum nitride powder to obtain a porous aluminum nitride matrix. Then, hydrothermal method was used to load ferrite on the surface of porous aluminum nitride matrix. Finally, the nickel ions are reduced by hydrazine in onium salt solvent to obtain aluminum nitride ceramic. Onium salt can complex with nickel ions and it also act as surfactants, causing the reduction of nickel ions to form nano nickel particles on the surface of ferrite.

Moreover, the hydrolysis of onium salt solution has alkalinity, which eliminates the need to add alkali during the reduction by hydrazine. So the reaction is more mild. It also avoids the nickel ions reduction in a short time. If the nickel ions are reduced in a short time, the nickel ions can not form nano nickel particles. If the alkalinity is too strong, nickel ions will be reduced immediately.

Beneficial effect: compared with the prior art, the present application has the following advantages:
(1) The porous structure in the aluminum nitride ceramic can provide a large number of reaction microchannels for the reforming hydrogen production reaction. the nano-nickel particles loaded on the surface of the pore wall can provide a large number of reactive active sites, which improves the hydrogen production. So, the aluminum nitride ceramic can improve the capacity and efficiency of the manufacture of hydrogen, and reduce the reaction space as well. All of these can contribute to the miniaturization of the reforming hydrogen production system.
(2) The ferrite in the aluminum nitride ceramic has a high dielectric constant. It can cause magneto-induced heating under the action of a magnetic field, so that the nano-nickel particles loaded on the surface can rapidly be heated up and catalyze the hydrogen production reaction.
(3) The aluminum nitride ceramic has the characteristics of high thermal conductivity, high strength, corrosion resistance and low expansion coefficient, so that the aluminum nitride porous ceramic can quickly transfer heat to the microreactor and maintain the stability of the reaction. Moreover, it meets the pressure required for hydrogen production by steam reforming. It meets the strength required for system assembly. At the same time, it meets the requirements of long-term hydrogen production without being corroded by water vapor under the condition of high specific surface area. Its dimensional size changes slightly while producing hydrogen. The above characteristics are beneficial to the stable operation of the microreactor.
(4) The preparation method of the aluminum nitride ceramic microreactor uses hydrazine to reduce nickel ions. Under the action of onium salt, the nano-nickel particles are loaded on the surface of the ferrite, so that the nano-nickel particles can be loaded high-efficiently. The ferrite can make the nickel particles be heated to the catalytic temperature rapidly.
(5) The microreactor can operate the reforming hydrogen production reaction in the micron-scale space, start the reforming hydrogen production in a short time, and make the reforming hydrogen production reaction proceed gently and efficiently. The reaction speed is 1-3 times of magnitude higher than that of the reaction speed of traditional reactor. So, the volume of the reaction device can be significantly reduced. So, we can see that these are helpful to realize the on-line hydrogen production on the vehicle.

### BRIEF DESCRIPTION OF THE FIGURES

FIG. 1 shows 400 times SEM image of the aluminum nitride ceramic prepared in Example 1;

FIG. 2 shows the SEM image of 20000 times of the aluminum nitride ceramic prepared in Example 1;

FIG. 3 shows TEM image of the aluminum nitride ceramic prepared in Example 1;

FIG. 4 shows 400 times the SEM image of the aluminum nitride ceramic prepared in Example 2;

FIG. 5 shows the SEM image of 20000 times of the aluminum nitride ceramic prepared in Example 2;

FIG. 6 shows a TEM image of the aluminum nitride ceramic prepared in Example 2.

### EXAMPLES

The aluminum nitride powder used in the embodiment of the application is purchased from Beijing Dongfang Taiyang Technology Co., Ltd., and the particle size of the powder is 2-5 microns.

### Example 1

The preparation method of aluminum nitride ceramic comprises the following steps:
(1) Add water and 1 wt % HPMC to the aluminum nitride powder to obtain 60 wt % aluminum nitride mud, then use extrusion molding to shape the aluminum nitride mud to obtain an aluminum nitride green body. The green body is sintered at 1650° C. to obtain a porous aluminum nitride matrix.
(2) FeCl₃·6H₂O and MnCl₂·4H₂O is dissolved in ethylene glycol, adding sodium acetate, polyethylene glycol and the aluminum nitride ceramic prepared in step (1) in ethylene glycol, and then performing a hydrothermal reaction at 180° C. to obtain porous aluminum nitride matrix loaded with MnFe₂O₄ ferrite. Wherein, the weight-to-volume ratio of iron salt, manganese salt, sodium acetate, surfactant and organic solvent is 3 g:1 g:10 g:3 g:120 mL.
(3) Put the porous aluminum nitride matrix loaded with ferrite into 1 mol/L nickel chloride solution, add 0.3 wt % HATU (2-(7-Azabenzotriazol-1-yl)-N,N,N′,N′-tetramethyluronium hexafluorophosphate), and then add 2 wt % hydrazine solution to obtain aluminum nitride ceramic.

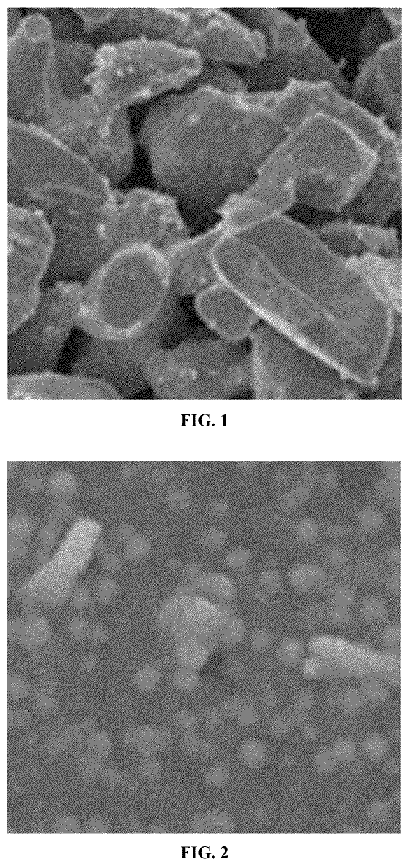

A 400-fold magnified SEM photo of the aluminum nitride ceramic prepared in Example 1 is shown in FIG. 1. FIG. 1 shows the pore size of AlN ceramic is 50-200 microns.

The porosity rate of the aluminum nitride ceramic prepared in Example 1 is 42% measured by the Archimedes drainage method.

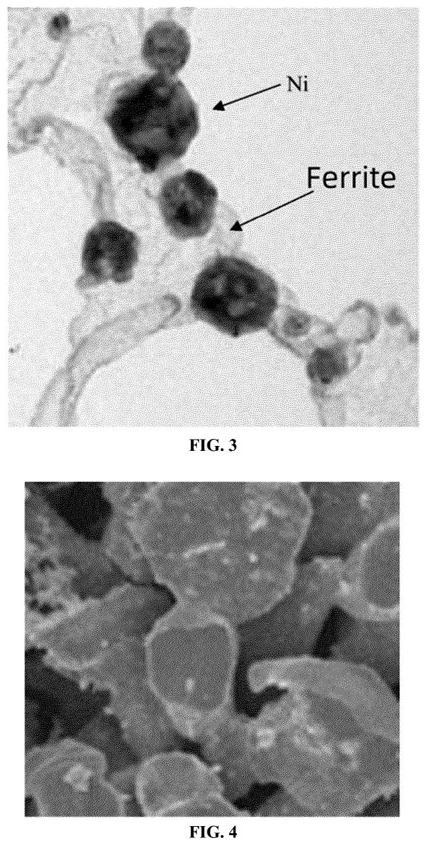

A 20,000-fold SEM photo of the aluminum nitride ceramic prepared in Example 1 is shown in FIG. 2. It can be seen from the figure that there are many ferrite particles loaded on the surface of aluminum nitride. FIG. 3 Shows the TEM photo of the aluminum nitride ceramic that example 1 prepares. From FIG. 3, it can be seen that the nano-nickel particles are loaded on the ferrite surface.

### Example 2

The preparation method of aluminum nitride ceramic comprises the following steps:
(1) Add water and 2 wt % CMC to the aluminum nitride powder to obtain 70 wt % aluminum nitride mud, then use extrusion molding to shape the aluminum nitride mud to obtain an aluminum nitride green body. The green body is sintered at 1800° C. to form a porous aluminum nitride matrix.
(2) FeCl₃·6H₂O and MnCl₂·4H₂O was dissolved in ethylene glycol, sodium acetate, polyethylene glycol and the aluminum nitride ceramic prepared in step (1) were added in ethylene glycol, and then hydrothermal reaction was carried out at 200° C. to obtain porous aluminum nitride matrix loaded with MnFe₂O₄ ferrite. Wherein, the weight-volume ratio of iron salt, manganese salt, sodium acetate, surfactant and organic solvent is 4:1.5:15 g:4 g:200 mL.
(3) Put the porous aluminum nitride matrix loaded with ferrite into 2 mol/L nickel chloride solution, add 0.4 wt % HBTU, and then add 2 wt % hydrazine solution to obtain aluminum nitride ceramic.

A 400-fold magnified SEM photo of the aluminum nitride ceramic prepared in example 2 is shown in FIG. 4. FIG. 4 shows the pore size of aluminum nitride ceramic is 60-180 microns. The porosity rate of the aluminum nitride ceramic prepared in example 2 is 61% measured by the Archimedes drainage method.

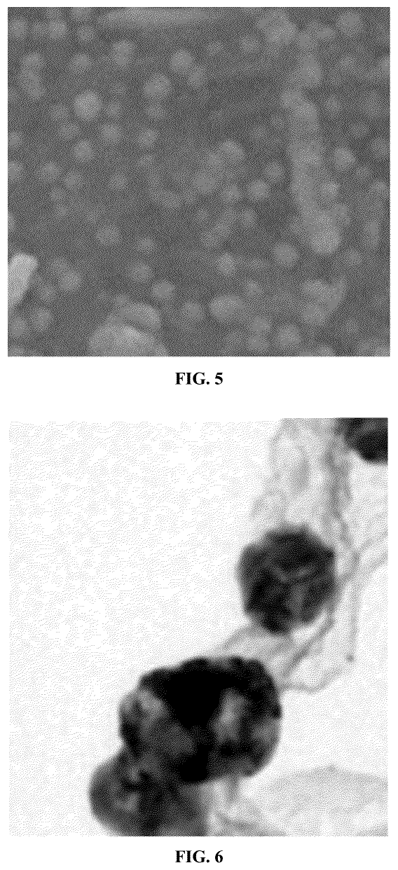

A 20,000-fold SEM photo of the aluminum nitride ceramic prepared in example 2 is shown in FIG. 5. It can be seen from the figure that there are many ferrite particles loaded on the surface of aluminum nitride.

FIG. 6 Show the TEM photo of the aluminum nitride ceramic that example 2 prepares.

From FIG. 6, it can be seen that the nano-nickel particles are loaded on the ferrite surface.

### Example 3

The preparation method of aluminum nitride ceramic comprises the following steps:
(1) Add water and 2 wt % hydroxyethyl cellulose to the aluminum nitride powder to obtain 80 wt % aluminum nitride mud, and then use extrusion molding to shape the aluminum nitride mud to obtain nitride green body. The aluminum green body is sintered at 1900° C. to obtain a porous aluminum nitride matrix.
(2) FeCl₃·6H₂O and MnCl₂·4H₂O was dissolved in ethylene glycol, sodium acetate, polyethylene glycol and the aluminum nitride ceramic prepared in step (1) were added in ethylene glycol, and then hydrothermal reaction was carried out at 190° C. to obtain porous aluminum nitride matrix loaded with MnFe₂04 ferrite. Wherein, the weight-to-volume ratio of iron salt, manganese salt, sodium acetate, surfactant and organic solvent is 5 g:2 g:20 g:5 g:200 mL.
(3) Put the porous aluminum nitride matrix loaded with ferrite into 3 mil/L nickel chloride solution, add 0.5 wt % HCTU, and then add 5 wt % hydrazine solution to obtain aluminum nitride ceramic.

The ferrite of the present application comprises MnFe₂04. Manganese ferrite has high heating efficiency and a high heating rate under the action of a high-frequency magnetic field.

The particle size of the nano-nickel particle is 20-200 nm. If the particle size is too large, the catalytic efficiency will decrease.

In the examples, the temperature of the hydrothermal reaction is 180-200° C. Preferably, the onium salt is HATU, HBTU, HCTU or TSTU. The addition amount of the onium salt in the nickel salt solution is 0.3-0.5 wt % of the nickel salt. The content of hydrazine in the hydrazine solution is 2-5 wt %. The binder is HPMC, hydroxymethylcellulose, hydroxyethylcellulose or CMC.

The sintering temperature in the examples are 1600-2000° C. The content of the binder in the aluminum nitride mud is 1-2 wt %, and the content of the aluminum nitride powder in the aluminum nitride mud is 60-80 wt %.

Iron salt in the examples is FeCl₃·6H₂O. The concentration of nickel ions in the nickel salt solution is 1-3 mol/L.

The manganese salt in the examples is MnCl₂·4H₂O. The organic solvent is ethylene glycol. The surfactant is polyethylene glycol.

The weight-to-volume ratio of iron salt, manganese salt, sodium acetate, surfactant, and organic solvent in the examples is 3-5 g: 1-2 g: 10-20 g: 3-5 g: 120-300 mL.

The microreactor of the present application is prepared by cutting aluminum nitride ceramic.

The application of the micro-reactor of the present application is applied to catalytic reforming of organic liquid fuel at high temperature to obtain hydrogen. Specifically, the gas delivery device is connected to the inlet end of the microreactor, the gas chromatograph is connected to the gas outlet end of the microreactor. After installing a heating device and a magnetic field generating device around the microreactor, and turning on the heating device and the magnetic field generating device, the microreactor is preheated. Then, delivering ethanol into the microreactor, the microreactor will start to produce hydrogen. The organic liquid fuel is alcohol containing 1-4 carbon atoms. Wherein the alcohol containing 1-4 carbon atoms is methanol, ethanol, propanol or glycerin.

The porosity rate of the aluminum nitride ceramic prepared in example 1 is 68% measured by the Archimedes drainage method.

The aluminum nitride ceramic prepared in example 1, example 2, and example 3 were cut into approximate cuboids to obtain microreactors. Connect the gas delivery device to the inlet end of the microreactor, connect the gas chromatograph to the gas outlet end of the microreactor, and set a heating device and a magnetic field generating device around the microreactor, then feed ethanol into the microreactor. Turn on the heating device and the magnetic field generating device, and the microreactor starts to produce hydrogen after being preheated.

It can be seen from Table 1 that the preheating time of the aluminum nitride ceramic prepared in example 1, example 2 and example 3 has been greatly shortened and the conversion rate of ethanol is high, so that the aluminum nitride ceramic prepared in example 1, example 2 and example 3 can be used for on-board hydrogen production.

TABLE 1

| | Preheating time/min | Ethanol conversion |
|---|---|---|
| Example 1 | 25 | 98.6% |
| Example 2 | 20 | 99.1% |
| Example 3 | 21 | 98.3% |

1. An aluminum nitride ceramic, comprising:
a porous aluminum nitride matrix, a ferrite and nano-nickel particles;
wherein the ferrite is loaded on the pore surface of the porous aluminum nitride matrix;
the nano-nickel particles are loaded on the surface of the ferrite;
a particle size of the nano-nickel particles is 20 to 200 nm.

2. The aluminum nitride ceramic of claim 1, wherein an apparent porosity rate of the porous aluminum nitride matrix is 35% to 70%.

3. The aluminum nitride ceramic of claim 1, wherein the porous aluminum nitride matrix has micron-order macropores.

4. The aluminum nitride ceramic of claim 3, wherein a diameter of the micron-order macropores is 50 to 200 microns.

5. A method of preparing the aluminum nitride ceramics of claim 1, the method comprising:
mixing aluminum nitride powder and binder then add water to obtain aluminum nitride mud;
shaping the aluminum nitride mud to obtain aluminum nitride green body; sintering the green body to obtain the porous aluminum nitride matrix;
dissolving iron salt and manganese salt in an organic solvent to obtain organic solution;
add sodium acetate, surfactant and the porous aluminum nitride matrix into the organic solution, and then carrying out hydrothermal reaction to obtain ferrite-loaded porous aluminum nitride matrix;
placing the porous aluminum nitride matrix loaded with ferrite in nickel salt solution, and then adding onium salt, and hydrazine solution into the nickel salt solution to obtain the aluminum nitride ceramics.

6. The method of preparing the aluminum nitride ceramics of claim 5, wherein the binder is HPMC, hydroxymethyl cellulose, hydroxyethyl cellulose or CMC.

7. The method of preparing the aluminum nitride ceramics of claim 5, wherein the iron salt comprises FeCl₃·6H₂O.

8. The method of preparing the aluminum nitride ceramics of claim 5, wherein the manganese salt comprises MnCl₂·4H₂0.

9. The method of preparing the aluminum nitride ceramics of claim 5, wherein the organic solvent comprises ethylene glycol.

10. The method of preparing the aluminum nitride ceramics of claim 5, wherein the surfactant comprises polyethylene glycol.

11. The method of preparing the aluminum nitride ceramics of claim 5, the method comprising:
dissolving 3-5 g of FeCl₃·6H₂O and of 1-2 g of MnCl₂·4H₂O in 120-300 mL of ethylene glycol to obtain organic solution;
adding 10-20 g of sodium acetate, 3-5 g of polyethylene glycol, and the porous aluminum nitride matrix into the organic solution, and then carrying out hydrothermal reaction at 180-200° C. to obtain porous aluminum nitride matrix loaded with ferrite.

12. The method of preparing the aluminum nitride ceramics of claim 5, wherein a concentration of nickel ions in the nickel salt solution is 1-3 mol/L.

13. The method of preparing the aluminum nitride ceramics of claim 5, wherein an addition amount of the onium salt in the nickel salt solution is 0.3 to 0.5 wt %.

14. The method of preparing the aluminum nitride ceramics of claim 5, wherein a content of hydrazine in the hydrazine solution is 2 to 5 wt %.

15. A microreactor, comprising: the aluminum nitride ceramic of claim 1; wherein the microreactor is prepared by cutting the aluminum nitride ceramic.

16. A method of preparing hydrogen, the method comprising:
using the microreactor of claim 15 to prepare organic liquid fuels to hydrogen.

17. The method of preparing hydrogen of claim 16, wherein the organic liquid fuels comprises alcohol with 1 to 5 carbon atoms.

18. A system, comprising:
gas delivery device, microreactor of claim 15, gas chromatograph, heating device, and magnetic field generating device;
wherein the gas delivery device links with an inlet end of the microreactor; the gas chromatograph is connected to the outlet end of the microreactor;
the heating device is installed around the microreactor; the magnetic field generating device is installed around the microreactor.

19. A method of preparing hydrogen, the method comprising:
delivering organic liquid fuels to a system comprising gas delivery device, a microreactor, gas chromatograph, heating device, and magnetic field generating device; wherein the gas delivery device links with an inlet end of the microreactor; the gas chromatograph is connected to the outlet end of the microreactor; the heating device is installed around the microreactor; the magnetic field generating device is installed around the microreactor; wherein the microreactor comprises: the aluminum nitride ceramic of claim 1; wherein the microreactor is prepared by cutting the aluminum nitride ceramic;
heating the microreactor meanwhile loading magnetic field on the microreactor.
